(19) United States
(12) Patent Application Publication
(10) Pub. No.: US 2025/0238807 A1
(43) Pub. Date: Jul. 24, 2025

(54) PREDICTIVE DATA PLACEMENT TO LEVERAGE SEASONAL GREEN ENERGY PRODUCTION

(71) Applicant: Dell Products L.P., Round Rock, TX (US)

(72) Inventors: Ahmed Khalid, Cork (IE); Alan Barnett, Co. Cork (IE); Stephen J. Todd, North Andover, MA (US); Aidan O’Mahony, Cork (IE)

(21) Appl. No.: 18/421,832

(22) Filed: Jan. 24, 2024

(51) Int. Cl. G06Q 30/018

(52) U.S. Cl. CPC G06Q 30/018

(57) ABSTRACT

One example method includes obtaining historical green energy production data that comprises information indicating when and where green energy was generated, obtaining green energy cost data that comprises information indicating a cost of green energy at various locations in various seasons, using the historical green energy production data and the green energy cost data to identify a potential target location for migration of a dataset from a current location of the dataset, and when a cost to perform the migration is lower, by a specified threshold amount, than a cost savings expected to be realized as a result of storing the dataset at the potential target location rather than at the current location, migrating the dataset from a current location of the dataset to the potential target location.

### FIELD OF THE INVENTION

Embodiments of the present invention generally relate to management of costs relating to data storage and data migration. More particularly, at least some embodiments of the invention relate to systems, hardware, software, computer-readable media, and methods, for migrating data to different geographic locations based, at least in part, on the availability and cost of green energy.

### BACKGROUND

Efforts have been made to decrease costs associated with energy consumption by moving power-hungry applications, and even hardware in some cases, near energy sources that provide low cost energy, at least as compared with the cost of energy at other locations, that can be used by such applications and hardware. In some instances, automated data placement has been employed as well to take advantage of low cost energy. However, approaches such as these, that is, involving placement of applications, hardware, and data, fail to consider other factors that may enable improvements in terms of the cost and efficiency of energy consumption.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an architecture according to one embodiment.

FIG. 2 discloses information about green energy generation on a regional, and seasonal, basis.

FIG. 3 discloses aspects of a method according to one embodiment.

FIG. 4 discloses an example computing entity configured, and operable, to perform any of the disclosed methods, processes, and operations.

### DETAILED DESCRIPTION OF SOME EXAMPLE EMBODIMENTS

Embodiments of the present invention generally relate to management of costs relating to data storage and data migration. More particularly, at least some embodiments of the invention relate to systems, hardware, software, computer-readable media, and methods, for migrating data to different geographic locations based, at least in part, on the availability and cost of green energy.

One example embodiment is directed to a method for leveraging seasonal green energy production. An example method may comprise the following operations: obtaining, from green energy producers, seasonal green energy production data for different geographic locations; using the data, determining respective green energy costs for the geographic locations at different times of the year; based on the green energy costs, migrating a dataset from one of the geographic locations with a higher green energy cost to another of the geographic locations with a lower green energy cost, when a difference between the lower green energy cost and the higher green energy costs exceeds a cost of the migrating by a predetermined margin. In an embodiment, any, or all, of the aforementioned operations may be performed automatically, and the method may be performed on a recurring basis, possibly based on ongoing changes in the green energy costs. In an embodiment, green energy may comprise electrical power, such as may be generated by one or more of the sources disclosed herein.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in anyway. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that trustworthy green energy data may be obtained directly from green energy providers and may be used to inform data migration decisions. In an embodiment, data may be migrated from one geographic location to another based at least in part on seasonal weather-induced green energy production and associated costs. Various other advantages of one or more example embodiments will be apparent from this disclosure.

### A. Aspects of an Example Architecture and Environment

The following is a discussion of aspects of an example architecture according to one embodiment. This discussion is not intended to limit the scope of the invention, or the applicability of the embodiments, in any way.

In general, embodiments of the invention may be implemented in connection with systems, software, and components, that individually and/or collectively implement, and/or cause the implementation of, data storage and transmission operations which may include, but are not limited to, data replication operations, IO replication operations, data read/write/delete operations, data deduplication operations, data backup operations, data restore operations, data cloning operations, data archiving operations, and disaster recovery operations. More generally, the scope of the invention embraces any operating environment in which the disclosed concepts may be useful.

Data may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, migration, and/or cloning, operations initiated by one or more clients or other elements of the operating environment. Example cloud environments, which may or may not be public, include storage environments that may provide data protection functionality for one or more clients.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

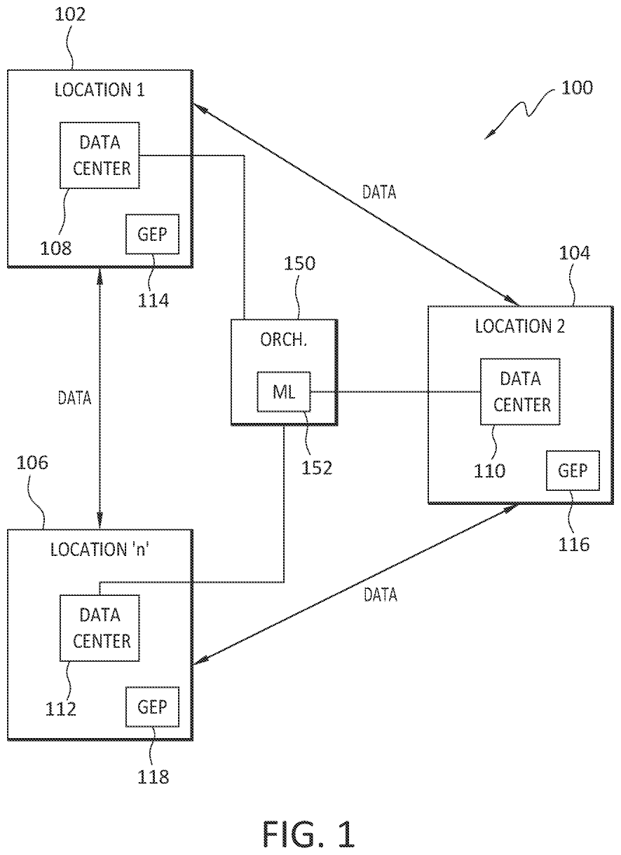

With particular attention now to FIG. 1, one example of an architecture according to one embodiment is denoted generally at 100. In general, the architecture 100 may embrace various geographic locations 102, 104, and 106. There is no limit to the number of geographic locations that may be employed or involved in an embodiment. A geographic location may be anywhere in the world, including on the surface of the earth, or underwater. In an embodiment, the geographic locations 102, 104, and 106, may be located in different respective climate zones, countries, states, provinces, longitudes, and/or latitudes. In an embodiment, the geographic locations 102, 104, and 106, may be selected based in whole, or in part, on respective green energy production sources, and associated green energy costs, at those geographic locations.

It is noted that a cost to store a dataset may be expressed in terms of the cost, such as in dollars or other currency for example, of the energy, such as electricity, that is needed to store, for example, ‘X’ Tb/day. That is, a cost for data storage may be expressed in terms of the cost of the energy that is required to be used to store a unit of data, per unit of time. This approach is provided only by way of example, and the cost to store data may be expressed in various alternative ways.

As well, a geographic location may be any size and location, and an embodiment may be employed within a single geographic location, or within a group of two or more geographic locations. Example geographic locations may include, but are not limited to, a country, a state, a province, a continent, a sea or ocean or river or lake, or any sub-portion of any of the foregoing example geographic locations.

Moreover, one or more of the geographic locations 102, 104, and 106, may be a location, such as a desert for example, where green energy, such as solar power for example, is reliably produced on an ongoing, rather than intermittent, basis. Other geographic locations 102, 104, and 106, may be associated with green energy sources whose production is only intermittent, and/or varies in amount, and cost, according to season. For example, a facility in southern France may reliably produce solar energy in the summer, but not in the winter. As such, green energy production, if any, in the winter may result in higher cost green energy as compared with the cost of the green energy produced in the summer. Thus, the amount and timing of green energy production may vary from one location to another, and from one season to another within one location and/or among multiple locations.

Accordingly, identifying, on an ongoing basis, the source(s), locations, and times, of the lowest cost energy may present an optimization opportunity that may be addressed by an embodiment of the invention. As noted elsewhere herein, an ML (machine learning) model may be used in an embodiment to make predictions or suggestions as to where and when data should be migrated.

With continued reference to FIG. 1, a respective datacenter 108, 110, and 112, or other data storage site, may be located at the geographic locations 102, 104, and 106. The datacenters 108, 110, and 112, may be configured to communicate with each other so that data can be migrated from one or more of the datacenters 108, 110, and 112 to another one or more of the datacenters 108, 110, and 112. Each of the geographic locations 102, 104, and 106, may also be associated with a respective green energy producer (GEP) 114, 116, and 118. In an embodiment, a geographic location 102, 104, or 106, may comprise, in addition or as an alternative to a GEP, an energy producer that is not a green energy producer, such as coal, natural gas, or nuclear power. In an embodiment, data may migrated, and stored, using power generated by a non-green energy producer.

The respective green energy outputs, which may be measured in kW/h for example, of the green energy producer 114, 116, and 118, may vary according to any one or more of [1] time of day, [2] season, and [3] geographic location. As used herein, ‘green energy’ includes, but is not limited to, solar-generated energy, wind-generated energy, hydroelectric energy, geothermal energy, biomass energy, tidal and wave generated energy, and biofuels.

One example embodiment may comprise an orchestrator 150 configured to communicate with the various datacenters 108, 110, and 112, and with the GEPs 114, 116, and 118. In an embodiment, the orchestrator 150 may request and receive information from the datacenters 108, 110, and 112, concerning parameters such as, but not limited to: the amounts of data to be transferred, or migrated, between datacenters 108, 110, and 112; the amounts of time expected to be needed to effect a migration of data; identification of the source, and target, datacenter(s) 108, 110, and 112; and, the timing of a data migration.

As well, the orchestrator 150 may request and receive information from the GEPs 114, 116, and 118, concerning various parameters relating to green energy. These parameters may include, but are not limited to: present and predicted costs, such as for one or more specified timeframes, of green energy; green energy historical production information; the availability, or not, of green energy during one or more specified timeframes; anticipated amount of green energy production for one or more specified time timeframes; the type of green energy available during particular timeframes; and, seasonal effects, if any, on green energy production.

The orchestrator 150 may use the information received from the datacenters 108, 110, and 112, and from the GEPs 114, 116, and 118, to make decisions as to what data should be migrated, from where, to where, and when. The orchestrator 150 may also consider, in making such decisions, the cost to migrate the data in question. For example, green energy may be cheaper in location 2 than in location 1, but if the cost to migrate the data from location 1 to location 2 exceeds, or is only slightly less than, the anticipated savings in energy costs expected to result from the migration, the orchestrator 150 may decide that there is not an adequate benefit in migrating the data.

To aid in decision-making, an embodiment of the orchestrator 150 may comprise an ML model 152 that may optimize data migration, migration timing, data placement, and data migration cost, to achieve maximum green energy cost savings within the architecture 100. The analysis as to maximization of green energy cost savings may be performed ad hoc, on an ongoing basis, or at one or more specified times, or according to set schedule. In an embodiment, the ML model 152 may generate inferences, which may comprise predictions, as to, for example, where and when data should be migrated.

It is noted that one embodiment may omit the orchestrator 150. In this example embodiment, each of the datacenters 108, 110, and 112, may operate autonomously, possibly using a dedicated hosted application, to minimize energy costs for data migration and storage on an individual datacenter basis. In this example embodiment, each of the datacenters 108, 110, and 112 may, or may not, comprise a respective ML model to optimize data migration, migration timing, data placement, and data migration cost, to achieve maximum green energy cost savings within the datacenter 108, 110, and 112. Where the ML model is present, the analysis as to maximization of green energy cost savings may be performed ad hoc, on an ongoing basis, or at one or more specified times, or according to a set schedule.

### B. Illustrative Map Example

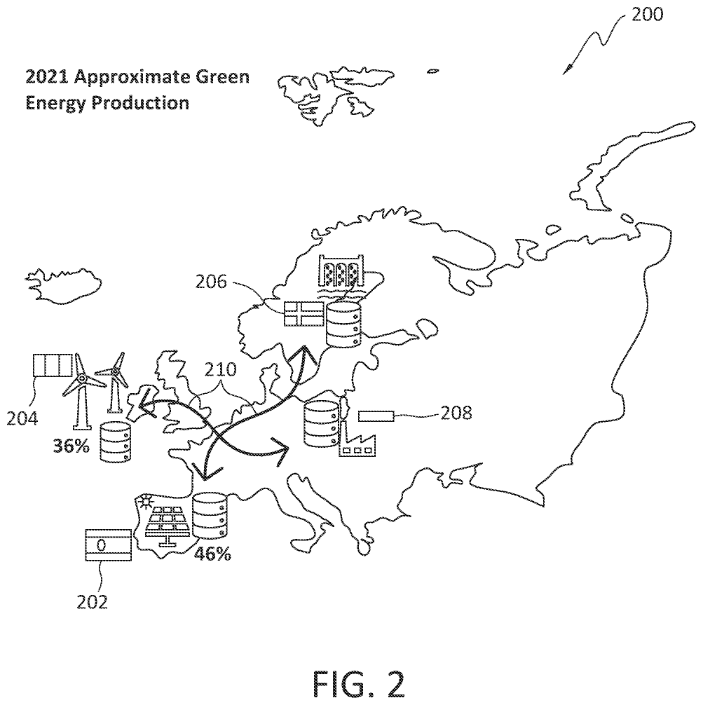

With reference briefly to FIG. 2, an example map 200 is disclosed that includes information about 2021 green energy production. As show, sustainable, or green, energy production may vary based on seasonal weather changes. The amount of green energy being produced by a nation 202, 204, 206, and 208, or region will change throughout the year. Historical data is available regarding these trends and may, in an embodiment, be leveraged to predict the optimum locations for leveraging green energy at a given time. These predictions, in turn, may inform data migration 210 and data placement decisions. To illustrate, in November 2022, the largest green energy power source in Ireland was wind, comprising 36% of the green energy generated in Ireland for that month/year. As another example, Andalusia in southern Spain produces a large volume of solar energy in the summer months. See, e.g.:
https://windenergyireland.com/about-wind/more-resources/monthly-dashboard; and
https://iea-pvps.org/wp-content/uploads/2023/08/National-Survey-Report-of-PV-Power-Applications-in-Spain-2022.pdf.

Thus, data may be moved from a more northerly location, such as Germany for example, to southern Spain, at least for summer months when energy may be less expensive. When the summer has ended in Spain, the data may be moved to a location, such as Ireland, where winter winds are expected that may generate energy for a lower cost than energy generated in Spain in the winter. These seasonal weather patterns are observable and typically repeat over time.

It is noted that higher or lower green energy costs are not necessarily a function of season only, or of only one season. For example, a location that is not particularly sunny may not generate significant solar energy, but if that location is windy, wind power energy generation may nonetheless be substantial enough to consider migrating data to that location. Thus, not only season, but local climatic conditions, whether in the air, on land, and/or in the sea, may also play a role in data migration and data placement decisions taken by an embodiment.

### C. Further Aspects of an Example Embodiment

Various incentives may exist for data migration. Some example incentives include, environmental impact, branding related to the use of green energy, and tax related incentives, such as company environmental certifications, and participation in the RE100 global initiative (https://www.there100.org/). Yet other incentives may be cost-related, such as the availability of relatively more energy, and lower cost energy.

As noted earlier, an embodiment may consider not only the cost of energy to power a datacenter from which, or to which, data is migrated. Rather, such embodiment may also consider the financial cost, and possible intangibles such as data security while data is in-flight between locations, of data migration and placement. For example, too-frequent data migrations may consume the cost savings in energy that might otherwise be realized by migrating data to a site where energy costs are lower.

Thus, an embodiment may comprise a predictive model, such as the ML model 152, that may use historic weather data, and renewable energy production data, for example, to draw inferences concerning data migration. For example, if southern Italy displays similar seasonal weather patterns to southern Spain, a new solar plant in this region may be inferred to yield similar productive months to those observed in Spanish solar plants.

An embodiment may comprise a plug-in to a data placement framework or mechanism, such as maybe located at a datacenter, to enable selection of locations from which to obtain data based on green energy output predictions. An embodiment may calculate the cost/benefit of migration/data placement, and detect unpredicted seasonal weather, such as real-time anomalies in the weather. As another example, an embodiment may implement ongoing measuring of accuracy of the model inferences, and may provide for enforcement of accountability for poor predictions causing losses, using metadata and a confidence fabric of the data placement framework for increased accuracy and trustworthiness.

In contrast with one embodiment, current data-placement approaches relating to sustainable energy are manual, that is, those approaches employ SLAs (service level agreements) that have been entered into between data owners and power providers. In contrast with one embodiment, these data-placement approaches do not migrate data to other geographic locations based on seasonal weather-induced green energy production, such as is done in an embodiment.

### D. Example Methods

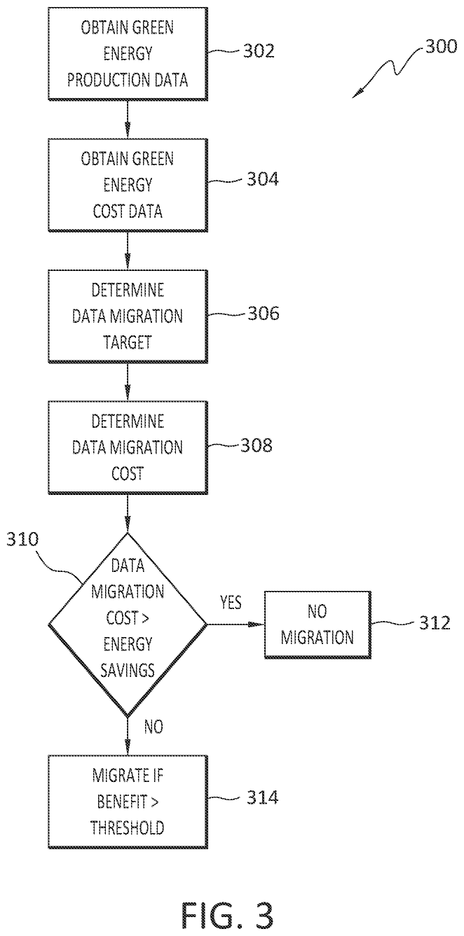

It is noted with respect to the disclosed methods, including the example method of FIG. 3, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 3, an example method according to one embodiment is denoted at 300. In an embodiment, the method 300 may be implemented in part, or in whole, by an ML model that has been trained with training data including, but not limited to, historical weather condition data, historical green energy costs, and historical data migration costs. The ML model may then generate inferences as to where and when a dataset should be migrated, and a data migration plan constructed and carried out based on those inferences.

The example method 300 may begin with obtaining green energy production data, possibly directly from the green energy producers, for various geographic locations and/or for various seasons within the geographic locations 302. The green energy production data, which may comprise present and/or historical data, may indicate, for example, how much green energy is produced, when, where, and by what source(s). In an embodiment, green energy production data may be predicted using historical green energy production information and seasonal weather information.

Next, green energy cost data may be obtained 304. It is noted that 304 and 302 may be performed in reverse order, or at about the same time. The green energy cost data may comprise, for example, the cost at which the green energy was sold, and/or is being sold, for various geographic locations and/or for various seasons within the geographic locations. In an embodiment, green energy cost data may be predicted using historical green energy cost information and seasonal weather information.

The green energy production data and the green energy cost data, whether predicted, historical, actual, or any combination of these, may then be used to determine 306 a data migration target to which a dataset may be migrated. In an embodiment, the determination 306 may comprise identification of location where energy cost savings are expected to be realized in connection with the storage of data at that location.

In an embodiment, the cost of data migration may be determined 308. For example, simply because green energy is less expensive in location A than in location B, the cost to migrate the data from location B to location A may exceed, or closely match, the savings expected to be realized by the migration. In a situation such as this, the economics may not support the migration.

Thus, the method 300 may comprise performing a check 310 to determine whether the data migration cost exceeds the expected cost savings. If so, a decision 312 may be made not to migrate the data to the location that was identified at 306. In this case, alternate locations may be sought, or the data may simply not be migrated.

Even if the cost of migration is less than the savings expected to be realized, so that there is a net gain in savings to be realized, the net gain may not be large enough to justify the migration. Thus, an embodiment may implement 314 a threshold savings margin that must be expected before the migration will be implemented. For example, if the overall cost of storing the data in a new location, after migration costs are accounted for, is equal to or greater than 10 percent less that retaining the data in its current location, the data may be migrated.

In an embodiment, any, or all, of the aforementioned operations may be performed automatically, and the method 300 may be performed on a recurring basis, possibly based on ongoing changes in the green energy costs. In an embodiment, green energy may comprise electrical power, such as may be generated by one or more of the sources disclosed herein.

### E. Further Example Embodiments

Following are some further example embodiments of the invention. These are presented only by way of example and are not intended to limit the scope of the invention in any way.

Embodiment 1. A method, comprising obtaining historical green energy production data that comprises information indicating when and where green energy was generated; obtaining green energy cost data that comprises information indicating a cost of green energy at various locations in various seasons; using the historical green energy production data and the green energy cost data to identify a potential target location for migration of a dataset from a current location of the dataset; and when a cost to perform the migration is lower, by a specified threshold amount, than a cost savings expected to be realized as a result of storing the dataset at the potential target location rather than at the current location, migrating the dataset from a current location of the dataset to the potential target location.

Embodiment 2. The method as recited in any preceding embodiment, wherein identifying the potential target location is performed using a machine learning model, and wherein inferences generated by the machine learning model are monitored on an ongoing basis for correlation with energy costs actually incurred when the dataset is migrated to the potential target location.

Embodiment 3. The method as recited in any preceding embodiment, wherein the historical green energy production data and/or the green energy cost data are obtained from one or more producers of the green energy.

Embodiment 4. The method as recited in any preceding embodiment, wherein the green energy comprises any of: solar-generated energy; wind-generated energy; hydroelectric energy; geothermal energy; biomass energy; tidal and wave generated energy; and biofuel(s).

Embodiment 5. The method as recited in any preceding embodiment, wherein when the cost to perform the migration of the dataset is higher than a cost savings expected to be realized as a result of storing the dataset at the potential target location rather than at the current location, the dataset is not migrated from the current location to the potential target location.

Embodiment 6. The method as recited in any preceding embodiment, wherein the information included in the historical green energy production data indicates one or more seasons during which the green energy was generated in one of the locations.

Embodiment 7. The method as recited in any preceding embodiment, wherein the information included in the historical green energy production data indicates one or more climatic conditions existing in one of the locations at a time, or times, during which the green energy was generated.

Embodiment 8. The method as recited in any preceding embodiment, wherein a machine learning model is used to performing an inferencing process that identifies, based on respective seasonal weather data for one or more of the locations, a potential new location for data storage.

Embodiment 9. The method as recited in any preceding embodiment, wherein a cost to store the dataset at the potential target location is less than a cost to store the dataset at the current location of the dataset.

Embodiment 10. The method as recited in any preceding embodiment, wherein when an unpredicted weather condition is detected at the current location, or at the potential target location, performing an assessment, based on the unpredicted weather condition, to determine whether the dataset should remain in the current location, or be migrated to the potential target location or elsewhere.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

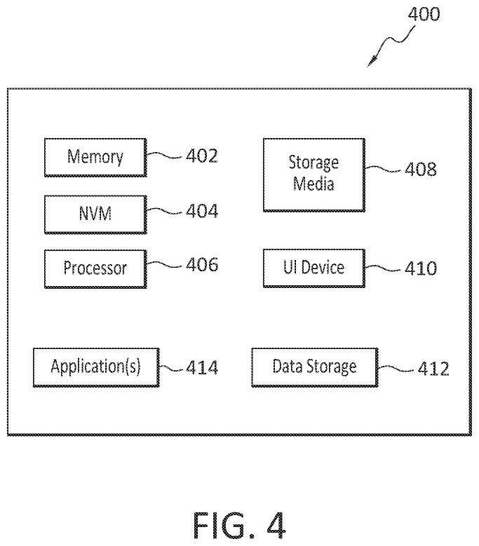

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
obtaining historical green energy production data that comprises information indicating when and where green energy was generated;
obtaining green energy cost data that comprises information indicating a cost of green energy at various locations in various seasons;
using the historical green energy production data and the green energy cost data to identify a potential target location for migration of a dataset from a current location of the dataset; and
when a cost to perform the migration is lower, by a specified threshold amount, than a cost savings expected to be realized as a result of storing the dataset at the potential target location rather than at the current location, migrating the dataset from a current location of the dataset to the potential target location.

2. The method as recited in claim 1, wherein identifying the potential target location is performed using a machine learning model, and wherein inferences generated by the machine learning model are monitored on an ongoing basis for correlation with energy costs actually incurred when the dataset is migrated to the potential target location.

3. The method as recited in claim 1, wherein the historical green energy production data and/or the green energy cost data are obtained from one or more producers of the green energy.

4. The method as recited in claim 1, wherein the green energy comprises any of: solar-generated energy; wind-generated energy; hydroelectric energy; geothermal energy; biomass energy; tidal and wave generated energy; and biofuel(s).

5. The method as recited in claim 1, wherein when the cost to perform the migration of the dataset is higher than a cost savings expected to be realized as a result of storing the dataset at the potential target location rather than at the current location, the dataset is not migrated from the current location to the potential target location.

6. The method as recited in claim 1, wherein the information included in the historical green energy production data indicates one or more seasons during which the green energy was generated in one of the locations.

7. The method as recited in claim 1, wherein the information included in the historical green energy production data indicates one or more climatic conditions existing in one of the locations at a time, or times, during which the green energy was generated.

8. The method as recited in claim 1, wherein a machine learning model is used to performing an inferencing process that identifies, based on respective seasonal weather data for one or more of the locations, a potential new location for data storage.

9. The method as recited in claim 1, wherein a cost to store the dataset at the potential target location is less than a cost to store the dataset at the current location of the dataset.

10. The method as recited in claim 1, wherein when an unpredicted weather condition is detected at the current location, or at the potential target location, performing an assessment, based on the unpredicted weather condition, to determine whether the dataset should remain in the current location, or be migrated to the potential target location or elsewhere.

11. A non-transitory storage medium having stored therein instructions that are executable by one or more hardware processors to perform operations comprising:
obtaining historical green energy production data that comprises information indicating when and where green energy was generated;
obtaining green energy cost data that comprises information indicating a cost of green energy at various locations in various seasons;
using the historical green energy production data and the green energy cost data to identify a potential target location for migration of a dataset from a current location of the dataset; and
when a cost to perform the migration is lower, by a specified threshold amount, than a cost savings expected to be realized as a result of storing the dataset at the potential target location rather than at the current location, migrating the dataset from a current location of the dataset to the potential target location.

12. The non-transitory storage medium as recited in claim 11, wherein identifying the potential target location is performed using a machine learning model, and wherein inferences generated by the machine learning model are monitored on an ongoing basis for correlation with energy costs actually incurred when the dataset is migrated to the potential target location.

13. The non-transitory storage medium as recited in claim 11, wherein the historical green energy production data and/or the green energy cost data are obtained from one or more producers of the green energy.

14. The non-transitory storage medium as recited in claim 11, wherein the green energy comprises any of: solar-generated energy; wind-generated energy; hydroelectric energy; geothermal energy; biomass energy; tidal and wave generated energy; and biofuel(s).

15. The non-transitory storage medium as recited in claim 11, wherein when the cost to perform the migration of the dataset is higher than a cost savings expected to be realized as a result of storing the dataset at the potential target location rather than at the current location, the dataset is not migrated from the current location to the potential target location.

16. The non-transitory storage medium as recited in claim 11, wherein the information included in the historical green energy production data indicates one or more seasons during which the green energy was generated in one of the locations.

17. The non-transitory storage medium as recited in claim 11, wherein the information included in the historical green energy production data indicates one or more climatic conditions existing in one of the locations at a time, or times, during which the green energy was generated.

18. The non-transitory storage medium as recited in claim 11, wherein a machine learning model is used to performing an inferencing process that identifies, based on respective seasonal weather data for one or more of the locations, a potential new location for data storage.

19. The non-transitory storage medium as recited in claim 11, wherein a cost to store the dataset at the potential target location is less than a cost to store the dataset at the current location of the dataset.

20. The non-transitory storage medium as recited in claim 11, wherein when an unpredicted weather condition is detected at the current location, or at the potential target location, performing an assessment, based on the unpredicted weather condition, to determine whether the dataset should remain in the current location, or be migrated to the potential target location or elsewhere.
